(19) United States
(12) Patent Application Publication
(10) Pub. No.: US 2001/0028408 A1
(43) Pub. Date: Oct. 11, 2001

(54) Digital broadcast receiving apparatus and receiving method, digital broadcast system, and digital broadcast transmitting/receiving method

(76) Inventor: Kazunori Arima, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/742,124

(22) Filed: Dec. 22, 2000

(30) Foreign Application Priority Data
Dec. 27, 1999 (JP) 11-371537

(51) Int. Cl. H04N 7/00; H04N 11/00

(52) U.S. Cl. 348/460; 348/552

(57) ABSTRACT

A digital broadcast receiving apparatus which realizes reservation for print-outputting information. A digital broadcast program and the type of information provided in the program are set in advance, and at broadcast time of the program, the apparatus automatically starts and receives digital broadcast of the program. Information related to the set type is extracted (steps S601 to S603) from the received data, and the extracted information is print-outputted (step S604).

### FIELD OF THE INVENTION

The present invention relates to digital broadcasting, and more particularly, to print-outputting information provided by digital broadcasting.

### BACKGROUND OF THE INVENTION

In digital broadcasting, various information are provided as well as video images by a so-called digital broadcasting. When a user print-outputs these information displayed on a display of digital-broadcast receiving apparatus, the user specifies information by using a remote control unit or the like while watching the display screen, and performs printing.

For example, in a case where the content of broadcasted program is about cooking and a cooking procedure as shown in FIG. 3 is broadcasted as animation while a recipe is data-broadcasted, the operator can call a data broadcast image as shown in FIG. 4.

Then, if the operator selects a recipe 4A in the displayed image, the recipe is displayed as shown in FIG. 5. In this image, if a print button 5A is selected, the displayed recipe is print-outputted.

Although this GUI provides excellent operability, the user must make these operations during the broadcast period. If the user is out during the broadcast period, the information cannot be print-outputted.

Further, to print-output information of weeklybase program, the user must make these operations every week. This is troublesome for the user.

### SUMMARY OF THE INVENTION

The main object of the present invention is to provide a digital broadcast receiving apparatus and receiving method, a digital broadcast system, and a digital broadcast transmitting/receiving method, for print-outputting information provided in a digital broadcast program without direct designation during a broadcast period.

According to an aspect of the present invention, the foregoing object is attained by providing a digital broadcast receiving apparatus comprising:

means for setting information of a digital broadcast program and the type of information provided in the program, in advance;

means for receiving digital broadcast of the program and extracting information related to the set type; and

printing means for print-outputting the extracted information.

Further, according to another aspect of the present invention, the foregoing object is attained by providing a digital broadcast receiving apparatus, connected to printing means for print-outputting information provided by digital broadcasting, comprising:

means for setting information of a digital broadcast program and the type of information provided in the program, in advance;

means for receiving digital broadcast of the program and extracting information related to the set type;

output means for outputting print data of the extracted information to said printing means.

Further, according to another aspect of the present invention, the foregoing object is attained by providing a digital broadcast receiving apparatus comprising:

designation means for, regarding information provided in a digital broadcast program, designating print-output of said information at the next and subsequent broadcast times;

storage means for storing the program and the type of said information designated by said designation means; and

means for performing print-output of information related to said type as to the stored program at the next and subsequent broadcast times.

Further, according to another aspect of the present invention, the foregoing object is attained by providing a digital broadcast receiving apparatus, connected to printing means for print-outputting information provided by digital broadcasting, comprising:

designation means for, regarding information provided in a digital broadcast program, designating print-output of said information at the next and subsequent broadcast times;

storage means for storing the program and the type of said information designated by said designation means;

means for outputting print data of information related to said type as to the stored program at the next and subsequent broadcast times to said printing means.

Further, according to another aspect of the present invention, the foregoing object is attained by providing a digital broadcast receiving method comprising:

a step of setting information of a digital broadcast program and the type of information provided in the program, in advance;

a step of receiving digital broadcast of the program and extracting information related to the set type; and

a printing step of print-outputting the extracted information.

Further, according to another aspect of the present invention, the foregoing object is attained by providing a digital broadcast receiving method comprising:

a designation step of, regarding information provided in a digital broadcast program, designating print-output of said information at the next and subsequent broadcast times;

a storing step of storing the program and the type of said information designated at said designation step; and

a step of performing print-output of information related to said type as to the stored program at the next and subsequent broadcast times.

Further, according to another aspect of the present invention, the foregoing object is attained by providing a recording medium on which a computer program for receiving digital broadcast is recorded, the computer program including:

code of a step of setting information of a digital broadcast program and the type of information provided in the program, in advance;

code of a step of receiving digital broadcast of the program and extracting information related to the set type; and

code of a printing step of print-outputting the extracted information.

Further, according to another aspect of the present invention, the foregoing object is attained by providing a recording medium on which a computer program for receiving digital broadcast is recorded, the computer program including:

code of a designation step of, regarding information provided in a digital broadcast program, designating print-output of said information at the next and subsequent broadcast times;

code of a storing step of storing the program and the type of said information designated at said designation step; and

code of a step of performing print-output of information related to said type as to the stored program stored at the next and subsequent broadcast times.

Further, according to another aspect of the present invention, the foregoing object is attained by providing a digital broadcast system having a transmitting apparatus for transmitting digital broadcast and a receiving apparatus for receiving digital broadcast, wherein the receiving apparatus comprising:

means for setting information of a digital broadcast program and the type of information provided in the program, in advance;

means for receiving digital broadcast of the program and extracting information related to the set type; and

means for outputting print data of the extracted information.

Further, according to another aspect of the present invention, the foregoing object is attained by providing a digital broadcast system having a transmitting apparatus for transmitting digital broadcast and a receiving apparatus for receiving digital broadcast, wherein the receiving apparatus comprising:

designation means for, regarding information provided in a digital broadcast program, designating print-output of said information at the next and subsequent broadcast times;

storage means for storing the program and the type of said information designated by said designation means; and

means for outputting print data of information related to said type as to the stored program at the next and subsequent broadcast times.

Further, according to another aspect of the present invention, the foregoing object is attained by providing a digital broadcast transmitting/receiving method including a transmission step of transmitting digital broadcast and a reception step of receiving the digital broadcast, wherein the reception step includes:

a step of setting information of a digital broadcast program and the type of information provided in the program, in advance;

a step of receiving digital broadcast of the program and extracting information related to the set type; and

a printing step of print-outputting the extracted information.

Further, according to another aspect of the present invention, the foregoing object is attained by providing a digital broadcast transmitting/receiving method including a transmission step of transmitting digital broadcast and a reception step of receiving the digital broadcast, wherein the reception step includes:

a designation step of, regarding information provided in a digital broadcast program, designating print-output of said information at the next and subsequent broadcast times;

a storage step of storing the program and the type of said information designated at said designation step; and

a step of performing print-output of information related to the type as to the stored program at the next and subsequent broadcast times.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a digital broadcast receiving apparatus A according to an embodiment of the present invention;

FIG. 2 is an explanatory view of the format of data transmitted in data broadcasting;

FIG. 3 is a display example of digital-broadcast video image;

FIGS. 4 and 5 are display examples of data broadcasting;

FIG. 6 is a flowchart showing information acquisition processing;

FIG. 7 is a display example of program reservation image;

FIG. 8 is an explanatory view of the format of data transmitted in the data broadcasting;

FIG. 9 is flowchart showing print processing;

FIG. 10 is a display example of information including a print-prohibited part;

FIG. 11 is an explanatory view of format of data transmitted in the data broadcasting;

FIG. 12 is an explanatory view of format of data transmitted in the data broadcasting;

FIG. 13 is a flowchart showing the print processing;

FIG. 14 is an explanatory view of format of data transmitted in the data broadcasting;

FIG. 15 is a flowchart showing the print processing;

FIG. 16 is a block diagram showing a digital broadcast receiving apparatus B according to another embodiment of the present invention;

FIG. 17 is a flowchart showing processing in a case where a printing unit 1E is in an abnormal status;

FIG. 18 is a flowchart showing processing corresponding to the case where the printing unit 1E enters an abnormal status during printing;

FIG. 19 is a flowchart showing interruption processing in the case where the printing unit 1E enters an abnormal status;

FIG. 20 is an example of construction of an input unit IF; and

FIG. 21 is a flowchart showing processing for reservation for the next information print-output.

### DETAILED DESCRIPTION OF THE PREFERRED EMBODIMENTS

Preferred embodiments of the present invention will now be described in detail in accordance with the accompanying drawings.

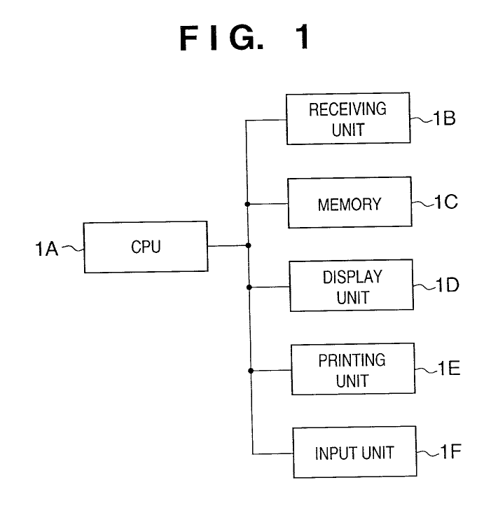

FIG. 1 is a block diagram showing a digital broadcast receiving apparatus A according to an embodiment of the present invention.

The receiving apparatus A has a CPU 1A for controlling the apparatus, a receiving unit 1B for receiving especially a data broadcast signal among digital broadcast signals and performing data conversion, a memory 1C including a buffer necessary for storing information from data broadcast or displaying and print-outputting the information, a display unit 1D for displaying the content or the like of obtained information, a printing unit 1E for print-outputting the obtained information, and an input unit 1F such as a remote control unit for inputting instructions from an operator. Note that as the printing unit 1E, a printer can be used. The printing unit may be installed in the receiving apparatus A as shown in the figure or may be provided as an external device.

Next, print reservation setting processing will be described.

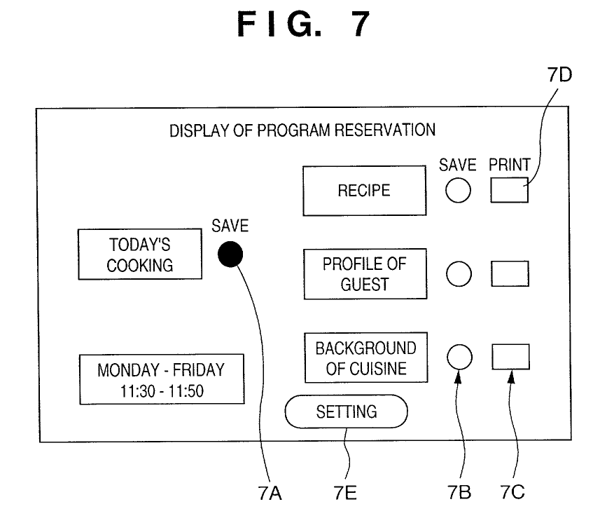

In the receiving apparatus A, the input unit 1F is used for reservation for print-outputting information of desired program. Especially, the reservation can be made at the same time of program recording reservation. FIG. 7 shows a display example of program reservation image in case of setting with respect to a program “Today's Cooking”. The image is used for setting as to storage or print-output of information provided in the recording-reserved program.

In FIG. 7, a button 7A is used for setting as to whether recording of program has been reserved or not. In FIG. 7, as recording of the program is also reserved, the button 7A is invert-displayed. Further, a button array 7B is used for setting as to whether or not information provided by the program is to be saved as electronic data. The button array 7B is provided for respective information.

A button array 7C is used for setting as to whether or not the information provided by the program is to be print-outputted. The button array 7C is provided for the respective information.

As a reservation operation, selection processing is made by operating the input unit 1F to move a cursor to the button of target information or the like to select the button. Upon selection, if the display is not inverted, the display is inverted as reserved state. Further, a reserved state is released by inverting the inverted display upon selection, thus an initial state is restored.

For example, to reserve print-output of information “recipe”, the input unit 1F is operated to move the cursor to a button 7D of button array 7C, and selection processing is performed to invert the display of the button 7D.

Then, when the reservation setting has been completed, the cursor is moved to a setting end button 7E to select the button, and the print reservation setting processing is terminated.

By this print reservation setting processing, the program as a target of printing and the type of information provided by the program are set, and stored in the memory 1C.

When broadcast time of the reserved program comes, the receiving apparatus A automatically receives the broadcast program.

Note that a table of programs for such reservation can be periodically obtained as electronic data from a digital broadcast station and can be stored in the memory 1C.

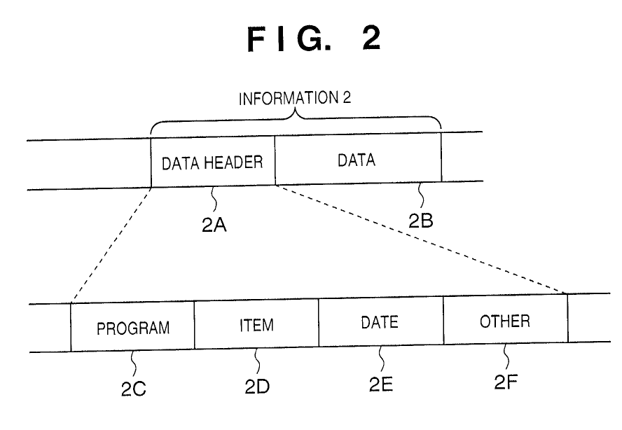

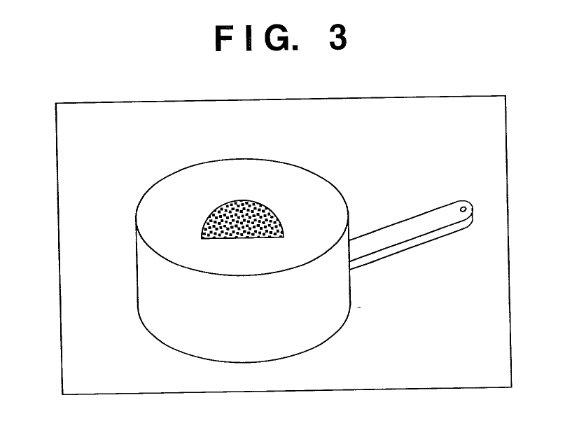

FIG. 2 shows the format of data transmitted in data broadcasting. As shown in FIG. 2, each information (2) provided in the data broadcasting has a data main body 2B and a data header 2A. The data header 2A includes program data 2C, item data 2D, date data 2E and other data 2F.

The program data 2C indicates a program to which the information 2 belongs. For example, if the information 2 is information on the program “Today's Cooking”, the program data includes data indicative of ID of the program.

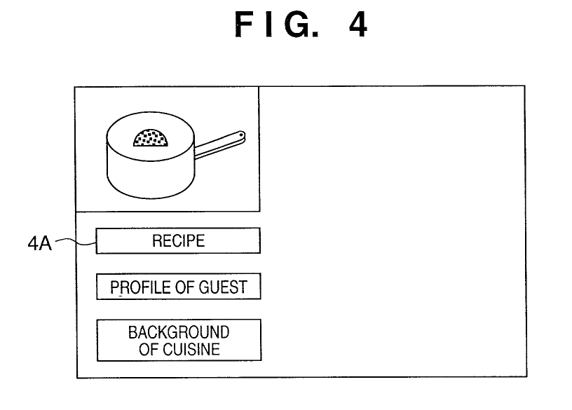

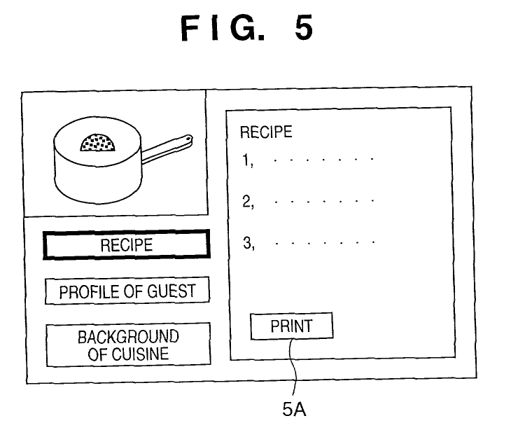

The item data 2D indicates the type of information 2 among information provided by the program. In the example of FIG. 4, there are three types of information provided by the program “Today's Cooking”, i.e., “recipe”, “profile of guest” and “background of cuisine”. The item data includes data to specify the information 2 as one of these types of information. if the information 2 is “recipe”, the item data includes a code corresponding to the “recipe”.

The date data 2E is data indicative of the broadcast time of the program to provide the information 2. Note that as the date data 2E merely specifies the program, the data may not indicate the broadcast time but may indicate ordinal position among all the broadcast dates or the like.

To read and print-output target information from data transmitted in the above data format, the data header 2A is referred to so as to judge whether the information corresponds to the target information. If the header corresponds to the target information, the data is read and converted into print data, and print-outputted by the printing unit 1E.

Especially, in a case where the target information is provided by a program broadcasted at fixed time from Monday to Friday, as only the date data 2E changes in the data header 2A, the target information can be obtained only by checking the data header 2A sent by the data broadcasting and judging whether the program data 2C and the item data 2D correspond to the target information.

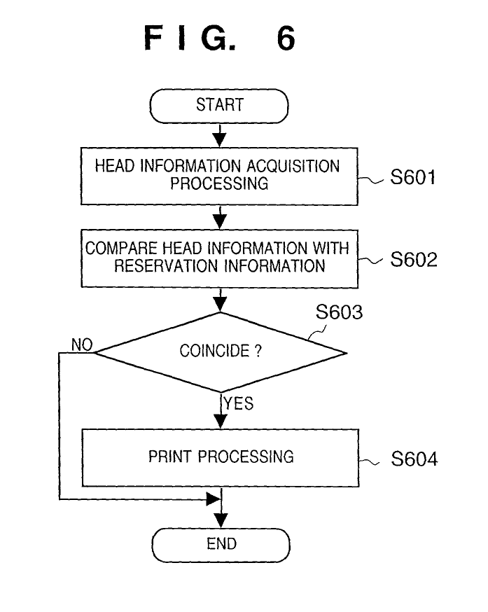

FIG. 6 is a flowchart showing the information acquisition processing.

When the broadcast time of program set by the above print reservation setting processing comes, the receiving apparatus A starts a reception operation to perform the following processing.

At step S601, the data header of received data is obtained. At step S602, the data header is compared with reservation information for print-output.

If it is judged at step 603 that the data header corresponds to the reservation information, the process proceeds to step S604, otherwise, the process ends.

In this manner, in the receiving apparatus A, desired information in a digital broadcast program can be reserved and print-outputted. Even if the user is out when the program is broadcasted, the information can be obtained. Further, in a case where the user watches the program, since the user does not have to make a print operation during the program, the user can watch the program with leisure.

Especially, in the present embodiment, as print-reservation can be made by a similar procedure to that for reservation of program for recording, the operation is simple.

On the other hand, a broadcast station occasionally desires to prohibit print-output depending on type of information in digital broadcast programs, e.g., print-output of information protected by copyright, right of portrait and the like. Next, print processing for information with permission or without permission will be described.

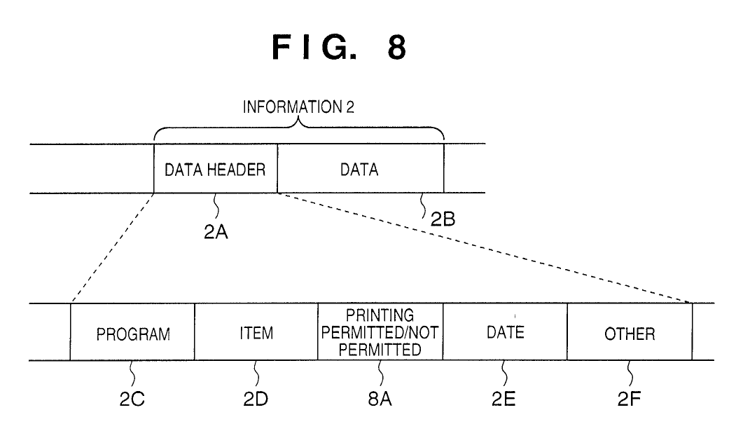

First, in the broadcast station, data to be transmitted is formed as follows. As shown in FIG. 8, an area 8A, indicating whether printing is permitted or not permitted, is provided in the data 2A described with reference to FIG. 2. In the receiving apparatus A, it is judged to perform or not to perform print processing based on the data in the area 8A.

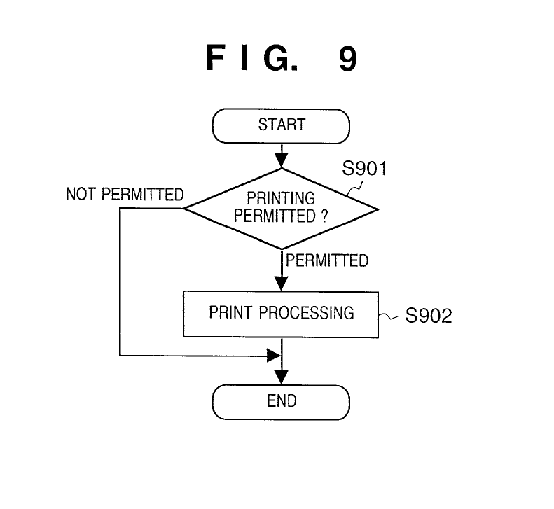

FIG. 9 is a flowchart showing the print processing. When it is judged whether printing is permitted or not permitted, step S604 in FIG. 6 is replaced by the processing in FIG. 9.

At step S901, the data in the area 8A is checked, to judge whether print-output of obtained information is permitted or not permitted.

If printing is permitted, the process proceeds to step S902, at which the information is print-outputted. If printing is not permitted, the process ends. In this case, regarding the information without permission, data on this matter may be recorded on the memory 1C so that it can be displayed later.

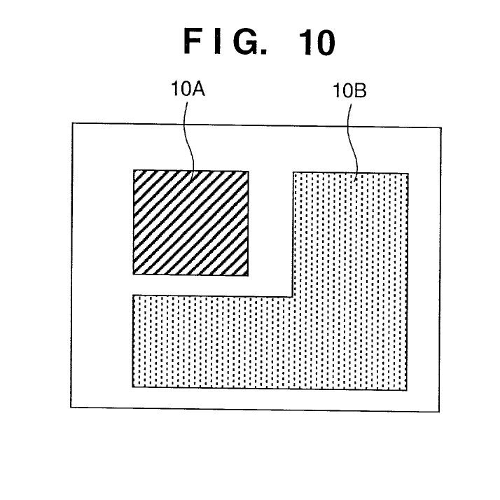

Note that in some information, print-output is partially prohibited. For example, in information as shown in FIG. 10, regarding a part 10B, print-output is permitted but regarding a part 10A, print-output is not permitted. In this case, the following two procedures may be taken.

As the first procedure, upon data transmission from the broadcast station side, data with permission and data without permission are separately transmitted, and the data header indicates the matter.

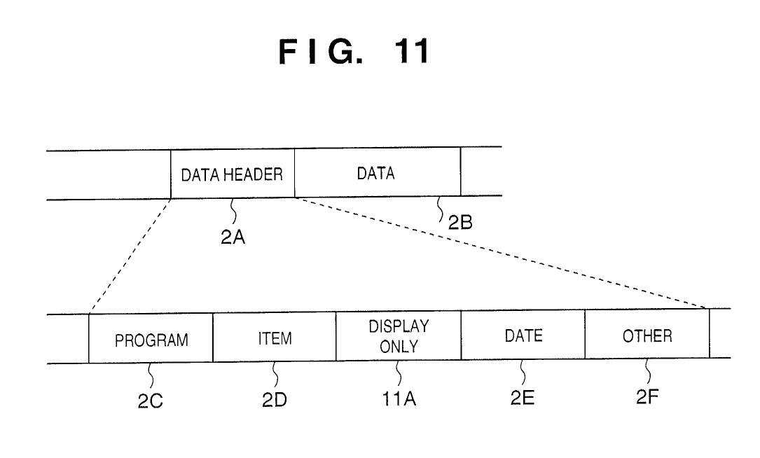

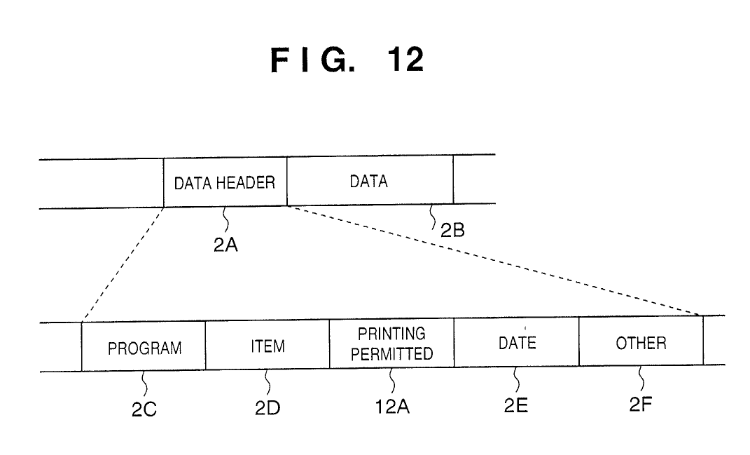

FIGS. 11 and 12 show data formats in this case.

In FIG. 11, numeral 11A denotes an area indicating that display is permitted but printing is not permitted. In FIG. 12, numeral 12A denotes an area indicating that printing is permitted (display is also permitted). In this case, the data 2B in FIG. 11 includes the part 10A in FIG. 10 and the data 2B in FIG. 12 includes the part 10B in FIG. 10.

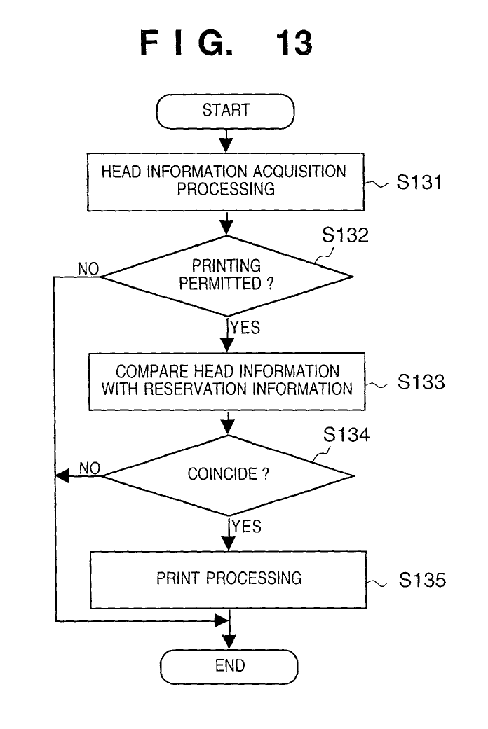

In this case, the processing shown in FIG. 6 is replaced by the following processing as shown in the flowchart of FIG. 13.

At step S132, it is judged from the data header of transmitted data whether print-output of information is permitted or not. If print-output is not permitted, the process ends.

If print-output of information is permitted, the data header is compared with the contents of reservation (step S133), and if the data header corresponds to the reservation, printing is performed (step S135), otherwise, the process ends.

In this manner, to permit or not to permit printing can be judged on the broadcast station side. Note that regarding information on the part without permission, data on this matter may be recorded on the memory 1C so that it can be displayed later.

Next, another procedure will be described. The data main body is divided into plural blocks, and a data header is provided in the respective blocks. Information as to printing is permitted or not permitted as shown in FIG. 8, is added to each header.

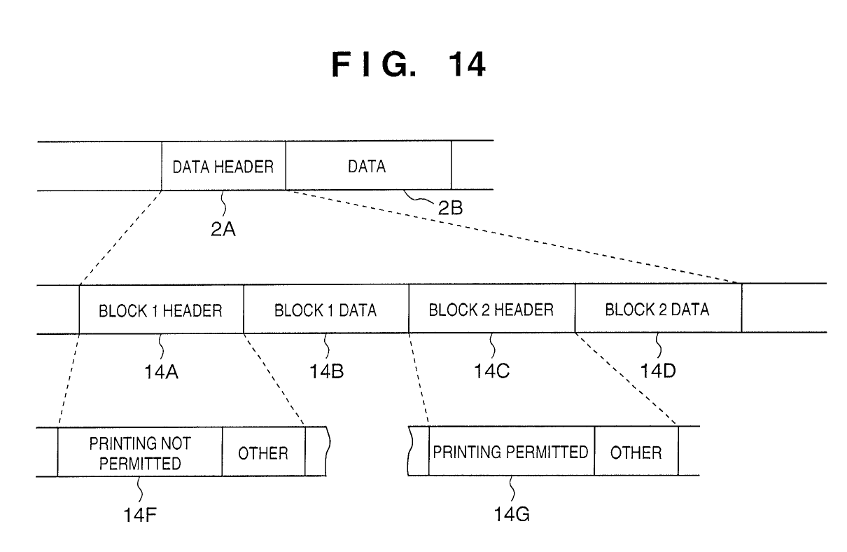

In the information in FIG. 10, assuming the data has two data blocks, the number of data to be transmitted is two, and the two data respectively have a data header and a data main body. FIG. 14 shows the data format in this case. That is, the data main body 2B has two blocks, a block 1 header 14A and block 1 data 14B, and a block 2 header 14C and block 2 data 14D.

In this example, information as to whether printing is permitted or not permitted is provided in the block 1 header 14A and the block 2 header 14B. That is, an area 14F indicates that printing is not permitted, while an area 14G indicates that printing is permitted, meaning that print-output of the block 1 data is not permitted while print-output of the block 2 data is permitted.

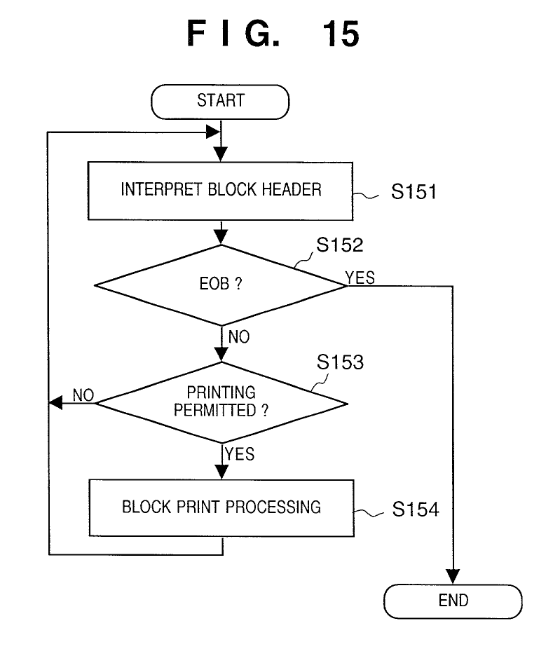

FIG. 15 is a flowchart showing the print processing in case of this data format.

When the receiving apparatus A has received data of target information, the block header included in the data main body 2B is interpreted at step S151.

In this example, block headers 14a and 14C are found, and EOB data indicating whether printing is permitted or not permitted are found.

Next, at step S152, it is judged whether or not EOB (a block (it has no data) having EOB in its block header indicative of the end of block of data set to be printed) exists.

When EOB has been found, since it is the end block of the data set, printing process ends. If there is no EOB in the block header interpreted at step S152, the process proceeds to step S153 at which it is judged whether printing is permitted or not. If printing is permitted, the subsequent data can be print-outputted, the process proceeds to step S154, at which print processing is performed. Thereafter, to print-output the next block, a search is made for a header.

If it is judged at step S153 that a block without permission has come, printing is not performed, and the process returns to step S151 to interpret the next block header. Note that regarding information on the part without permission, data on this matter may be recorded on the memory 1C so that it can be displayed later.

Next, description will be made about a receiving apparatus B which automatically stores obtained information when the printing unit 1E cannot perform printing due to shortage of paper, exhaustion of ink or the like (in abnormal status).

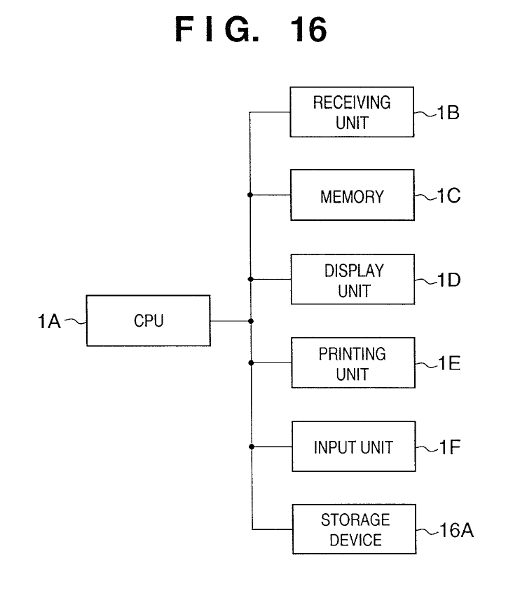

FIG. 16 is a block diagram showing the receiving apparatus B. The construction of the receiving apparatus B is that same as that of the receiving apparatus A, but the construction further has a storage device 16A such as a HDD.

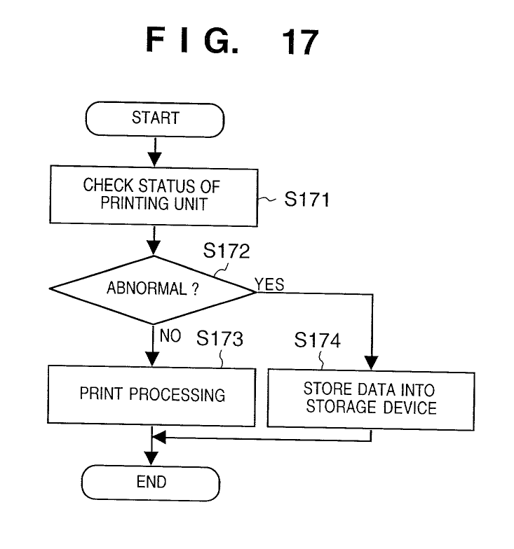

FIG. 17 is a flowchart showing processing performed by the receiving apparatus B in a case where the printing unit 1E enters an abnormal status.

At step S173, the status of the printing unit 1E is checked. At step S172, it is judged whether or not the printing unit 1E is in an abnormal status, and if it is judged that the printing unit 1E is not in an abnormal status, print processing is performed at step S173 as in a normal status.

If it is judged that the printing unit 1E is in an abnormal status, the process proceeds to step S174, at which obtained information is stored into the storage device 16A. Then the process ends.

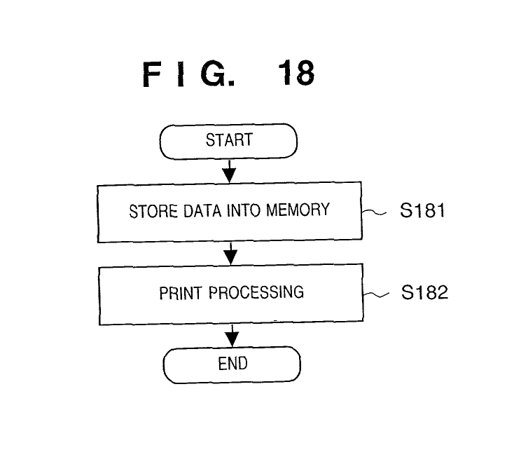

Note that it may be arranged such that the status of the printing unit 1E is always checked, and if an abnormality is found during print processing (in such case, interruption occurs), the printing is stopped, and the obtained information is stored. In this case, it is preferable that information which has been used in printing is also stored. Accordingly, it may be arranged as shown in FIG. 18 such that the obtained information is temporarily stored into the memory 1C (step S181) and print processing (step S182) is performed.

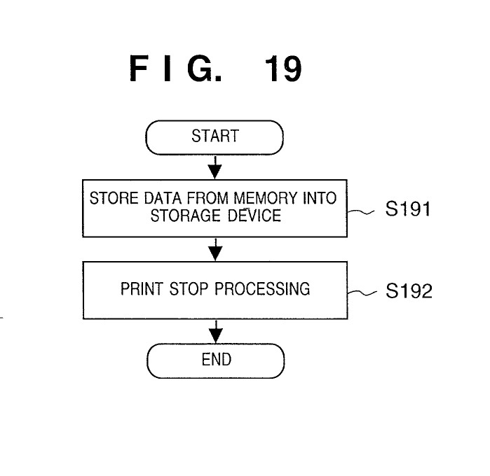

Then, during the print processing (S182), if an abnormality occurs in the printing unit 1E, interruption processing as shown in FIG. 19 is performed. In the interruption processing, first, the information stored in the memory 1C is stored into the storage device 16A (step S191), then print stop processing 19B is performed (step S192), then the interruption processing ends.

In this manner, even upon occurrence of abnormality in the printing unit 1E, delivered information can be stored in the storage device 16A.

Next, description will be made about a system in which, if information of a program is print-outputted from a broadcast display image, information of the same program is automatically print-outputted from the next or subsequent broadcast times. That is, in this system, regarding information of a program which has been once print-processed, reservation is made for automatic print-output at the next or subsequent broadcast times. Note that even regarding a program from which print processing has not been performed but merely received, reservation for automatic print-output can be made. The next or subsequent broadcast times means only any one of the next and subsequent broadcast times or all the next and subsequent broadcast times.

The system may be realized in the above-described receiving apparatus A or B, however, it may be constructed as a specialized independent apparatus. Hereinbelow, the system realized in the receiving apparatus A will be described.

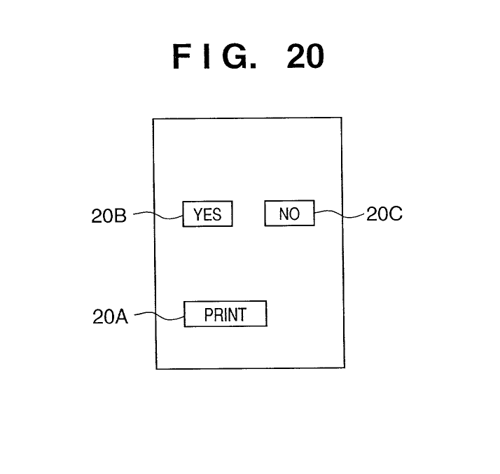

FIG. 20 shows the arrangement of keys of remote control unit as the input unit IF.

Reference 20A denotes a print start key which triggers print processing.

Numerals 20B and 20C denote keys for the operator's response to a query from the receiving apparatus A. The key 20B is a “Yes” key for an affirmative response, and the key 20C, a “No” key for a negative response.

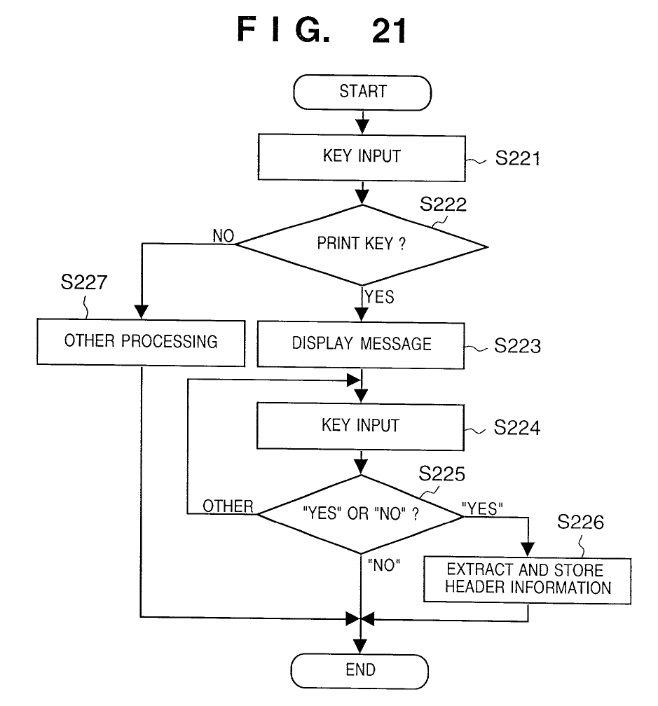

FIG. 21 is a flowchart showing processing for reservation for next information print-output. The receiving apparatus A receives a program and is displaying it.

At step S211, key-input from the remote control unit 1F is waited. When key-input has been made, it is judged whether or not the key-input has been made by depression of the print start key 20A. If it is judged that the print start key 20A has not been depressed, the process proceeds to other processing (step S227).

If it is judged that the print start key 20A has been depressed, first, a message asking whether or not reservation is to made for printing upon next broadcast time is displayed (step S223). Then a response from the operator is waited. If the “Yes” key 20B is depressed, the process proceeds to step S226, otherwise, the process ends.

At step S226, target information, e.g., the program data 2C and the item data 2D as shown in FIG. 2, are stored into the memory 1C, and the process ends.

By the above processing, upon the next broadcast time, the receiving apparatus A automatically starts and receives the program, to obtain information corresponding to the program data and the item data stored in the memory 1C.

As described above, in the preferred embodiments, print-output of information provided in a digital broadcast program can be performed even the printing is not directly designated during the broadcast.

As described above, in the preferred embodiments of the present invention, if the above-described printing reservation is made, it may be arranged such that the operator can grasp the print reservation status from display indicating the matter on the display unit 1D or an LED or the like provided on the apparatus.

Further, it may be arranged such that when printing reservation is made, the status of the printing unit 1E is checked, and if the printing unit 1E is not ready for printing, the matter is displayed. In this case, the operator can make preparations for printing, thus a printing error and the like can be prevented.

Further, in the above embodiment, a program is broadcasted from the broadcast station 201 via a radio wave, however, other signal transmission means such as an optical cable via the Internet may be used.

Further, the object of the present invention can be also achieved by providing a storage medium (or recording medium) storing software program code for performing the aforesaid functions of the embodiments to a system or an apparatus, reading the program code with a computer (e.g., CPU, MPU) of the system or apparatus from the storage medium, then executing the program. In this case, the program code read from the storage medium realizes the functions according to the embodiments, and the storage medium storing the program code constitutes the invention. Furthermore, besides aforesaid functions according to the above embodiments are realized by executing the program code which is read by a computer, the present invention includes a case where an OS (operating system) or the like working on the computer performs a part or entire processes in accordance with designations of the program code and realizes functions according to the above embodiments.

Furthermore, the present invention also includes a case where, after the program code read from the storage medium is written in a function expansion card which is inserted into the computer or in a memory provided in a function expansion unit which is connected to the computer, CPU or the like contained in the function expansion card or unit performs a part or entire process in accordance with designations of the program code and realizes functions of the above embodiments.

As many apparently widely different embodiments of the present invention can be made without departing from the spirit and scope thereof, it is to be understood that the invention is not limited to the specific embodiments thereof except as defined in the appended claims.

What is claimed is:

1. A digital broadcast receiving apparatus comprising:
means for setting information of a digital broadcast program and the type of information provided in the program, in advance;
means for receiving digital broadcast of the program and extracting information related to the set type; and
printing means for print-outputting the extracted information.

2. A digital broadcast receiving apparatus, connected to printing means for print-outputting information provided by digital broadcasting, comprising:
means for setting information of a digital broadcast program and the type of information provided in the program, in advance;
means for receiving digital broadcast of the program and extracting information related to the set type;
output means for outputting print data of the extracted information to said printing means.

3. A digital broadcast receiving apparatus comprising:
designation means for, regarding information provided in a digital broadcast program, designating print-output of said information at the next and subsequent broadcast times;
storage means for storing the program and the type of said information designated by said designation means; and
means for performing print-output of information related to said type as to the stored program at the next and subsequent broadcast times.

4. A digital broadcast receiving apparatus, connected to printing means for print-outputting information provided by digital broadcasting, comprising:
designation means for, regarding information provided in a digital broadcast program, designating print-output of said information at the next and subsequent broadcast times;
storage means for storing the program and the type of said information designated by said designation means;
means for outputting print data of information related to said type as to the stored program at the next and subsequent broadcast times to said printing means.

5. The digital broadcast receiving apparatus according to claim 3, wherein the program and the type of information are stored into said storage means only in accordance with designation from an operator.

6. The digital broadcast receiving apparatus according to claim 4, wherein the program and the type of information are stored into said storage means only in accordance with designation from an operator.

7. The digital broadcast receiving apparatus according to claim 1, further comprising:
means for judging whether or not print-output of said information is permitted; and
means for prohibiting print-output of said information if the print-output is not permitted.

8. The digital broadcast receiving apparatus according to claim 2, further comprising:
means for judging whether or not print-output of said information is permitted; and
means for prohibiting print-output of said information if the print-output is not permitted.

9. The digital broadcast receiving apparatus according to claim 3, further comprising:
means for judging whether or not print-output of said information is permitted; and
means for prohibiting print-output of said information if the print-output is not permitted.

10. The digital broadcast receiving apparatus according to claim 4, further comprising:
means for judging whether or not print-output of said information is permitted; and
means for prohibiting print-output of said information if the print-output is not permitted.

11. The digital broadcast receiving apparatus according to claim 1, further comprising:
means for judging whether or not the extracted information includes an information part print-output of which is not permitted; and
means for, if said information includes the information part print-output of which is not permitted, prohibiting print-output of only the information part.

12. The digital broadcast receiving apparatus according to claim 2, further comprising:
means for judging whether or not the extracted information includes an information part print-output of which is not permitted; and
means for, if said information includes the information part print-output of which is not permitted, prohibiting print-output of only the information part.

13. The digital broadcast receiving apparatus according to claim 3, further comprising:
means for judging whether or not the extracted information includes an information part print-output of which is not permitted; and
means for, if said information includes the information part print-output of which is not permitted, prohibiting print-output of only the information part.

14. The digital broadcast receiving apparatus according to claim 4, further comprising:
means for judging whether or not the extracted information includes an information part print-output of which is not permitted; and
means for, if said information includes the information part print-output of which is not permitted, prohibiting print-output of only the information part.

15. The digital broadcast receiving apparatus according to claim 1, further comprising:
means for judging whether or not said printing means is in a normal status; and
means for storing said information if said printing means is not in the normal status.

16. The digital broadcast receiving apparatus according to claim 2, further comprising:
means for judging whether or not said printing means is in a normal status; and
means for storing said information if said printing means is not in the normal status.

17. The digital broadcast receiving apparatus according to claim 3, further comprising:
means for judging whether or not said printing means is in a normal status; and
means for storing said information if said printing means is not in the normal status.

18. The digital broadcast receiving apparatus according to claim 4, further comprising:
means for judging whether or not said printing means is in a normal status; and
means for storing said information if said printing means is not in the normal status.

19. A digital broadcast receiving method comprising:
a step of setting information of a digital broadcast program and the type of information provided in the program, in advance;
a step of receiving digital broadcast of the program and extracting information related to the set type; and
a printing step of print-outputting the extracted information.

20. A digital broadcast receiving method comprising:
a designation step of, regarding information provided in a digital broadcast program, designating print-output of said information at the next and subsequent broadcast times;
a storing step of storing the program and the type of said information designated at said designation step; and
a step of performing print-output of information related to said type as to the stored program at the next and subsequent broadcast times.

21. A recording medium on which a computer program for receiving digital broadcast is recorded, said computer program including:
code of a step of setting information of a digital broadcast program and the type of information provided in the program, in advance;
code of a step of receiving digital broadcast of the program and extracting information related to the set type; and
code of a printing step of print-outputting the extracted information.

22. A recording medium on which a computer program for receiving digital broadcast is recorded, said computer program including:
code of a designation step of, regarding information provided in a digital broadcast program, designating print-output of said information at the next and subsequent broadcast times;
code of a storing step of storing the program and the type of said information designated at said designation step; and
code of a step of performing print-output of information related to said type as to the stored program stored at the next and subsequent broadcast times.

23. A digital broadcast system having a transmitting apparatus for transmitting digital broadcast and a receiving apparatus for receiving digital broadcast,
wherein said receiving apparatus comprising:
means for setting information of a digital broadcast program and the type of information provided in the program, in advance;
means for receiving digital broadcast of the program and extracting information related to the set type; and
means for outputting print data of the extracted information.

24. A digital broadcast system having a transmitting apparatus for transmitting digital broadcast and a receiving apparatus for receiving digital broadcast,
wherein said receiving apparatus comprising:
designation means for, regarding information provided in a digital broadcast program, designating print-output of said information at the next and subsequent broadcast times;
storage means for storing the program and the type of said information designated by said designation means; and
means for outputting print data of information related to said type as to the stored program at the next and subsequent broadcast times.

25. The digital broadcast system according to claim 23, wherein said transmitting apparatus separately transmits said information as information with print permission and as information without print permission,
and said receiving apparatus further comprises:
judgment means for judging whether or not said information is information without print permission; and
means for prohibiting output of print data of said information if said information is information without print permission.

26. The digital broadcast system according to claim 24, wherein said transmitting apparatus separately transmits said information as information with print permission and as information without print permission,
and said receiving apparatus further comprises:
judgment means for judging whether or not said information is information without print permission; and
means for prohibiting output of print data of said information if said information is information without print permission.

27. The digital broadcast system according to claim 23, wherein if said information has an information part without print permission, said transmitting apparatus separately transmits said information as the information part and another information part,
and said receiving apparatus further comprises:
judgment means for judging whether or not said information is information without print permission; and
means for prohibiting output of print data of said information if said information is information without print permission.

28. The digital broadcast system according to claim 24, wherein if said information has an information part without print permission, said transmitting apparatus separately transmits said information as the information part and another information part,
and said receiving apparatus further comprises:
judgment means for judging whether or not said information is information without print permission; and
means for prohibiting output of print data of said information if said information is information without print permission.

29. The digital broadcast system according to claim 25, wherein said transmitting apparatus transmits data related to said information as a header and a main body, and said header indicates whether or not print-output of said information is permitted,
and wherein said judgment means of said receiving apparatus reads said header and judges whether or not said information is information without print permission.

30. The digital broadcast system according to claim 26, wherein said transmitting apparatus transmits data related to said information as a header and a main body, and said header indicates whether or not print-output of said information is permitted,
and wherein said judgment means of said receiving apparatus reads said header and judges whether or not said information is information without print permission.

31. The digital broadcast system according to claim 27, wherein said transmitting apparatus transmits data related to said information as a header and a main body, and said header indicates whether or not print-output of said information is permitted,
and wherein said judgment means of said receiving apparatus reads said header and judges whether or not said information is information without print permission.

32. The digital broadcast system according to claim 28, wherein said transmitting apparatus transmits data related to said information as a header and a main body, and said header indicates whether or not print of said information is permitted,
and wherein said judgment means of said receiving apparatus reads said header and judges whether or not said information is information without print permission.

33. The digital broadcast system according to claim 27, wherein said transmitting apparatus transmits data related to said information as a header and a main body, said main body comprising a plurality of blocks including blocks of said information part and blocks of said another information part, each of the blocks having a header indicating whether or not print-output of the block is permitted and a main body of the block,
and wherein said judgment means of said receiving apparatus reads said header of said block and judges whether or not print-output of the block is permitted.

34. The digital broadcast system according to claim 28, wherein said transmitting apparatus transmits data related to said information as a header and a main body, said main body comprising a plurality of blocks including blocks of said information part and blocks of said another information part, each of the blocks having a header indicating whether or not print-output of the block is permitted and a main body of the block,
and wherein said judgment means of said receiving apparatus reads said header of said block and judges whether or not print-output of the block is permitted.

35. The digital broadcast system according to claim 23, wherein said receiving apparatus is connected to printing means to which said print data is outputted,
and wherein said receiving apparatus further comprises:
means for judging whether or not said printing means is in an normal status; and
means for storing said information if said printing means is not in the normal status.

36. The digital broadcast system according to claim 24, wherein said receiving apparatus is connected to printing means to which said print data is outputted,
and wherein said receiving apparatus further comprises:
means for judging whether or not said printing means is in a normal status; and
storage means for storing said information if said judgment means judges that said printing means is not in the normal status.

37. A digital broadcast transmitting/receiving method including a transmission step of transmitting digital broadcast and a reception step of receiving the digital broadcast,
wherein said reception step includes:
a step of setting information of a digital broadcast program and the type of information provided in the program, in advance;
a step of receiving digital broadcast of the program and extracting information related to the set type; and
a printing step of print-outputting the extracted information.

38. A digital broadcast transmitting/receiving method including a transmission step of transmitting digital broadcast and a reception step of receiving the digital broadcast,
wherein said reception step includes:
a designation step of, regarding information provided in a digital broadcast program, designating print-output of said information at the next and subsequent broadcast times;
a storage step of storing the program and the type of said information designated at said designation step; and
a step of performing print-output of information related to the type as to the stored program at the next and subsequent broadcast times.

39. The digital broadcast transmitting/receiving method according to claim 37, wherein at said transmission step, said information is transmitted separately as information with print permission and information without print permission,
and wherein said reception step includes:
a judgment step of judging whether or not said information is information without print permission; and
a step of prohibiting output of print data of said information if print-output is not permitted.

40. The digital broadcast transmitting/receiving method according to claim 38, wherein at said transmission step, said information is transmitted separately as information with print permission and information without print permission,
and wherein said reception step includes:
a judgment step of judging whether or not said information is information without print permission; and
a step of prohibiting output of print data of said information if print-output is not permitted.

41. The digital broadcast transmitting/receiving method according to claim 37, wherein if said information has an information part without print permission, at said transmission step, said information is transmitted separately as the information part and another information part,
and said reception step includes:
a judgment step of judging whether or not said information is information without print permission; and
a step of prohibiting output of print data of said information if said information is information without print permission.

42. The digital broadcast transmitting/receiving method according to claim 38, wherein if said information has an information part without print permission, at said transmission step, said information is transmitted separately as the information part and another information part,
and said reception step includes:
a judgment step of judging whether or not said information is information without print permission; and
a step of prohibiting output of print data of said information if said information is information without print permission.

43. The digital broadcast transmitting/receiving method according to claim 39, wherein at said transmission step, data related to said information is transmitted as a header and a main body, and said header indicates whether or not print-output of said information is permitted,
and wherein at said judgment step in said reception step, said header is read and it is judged whether or not said information is information without print permission.

44. The digital broadcast transmitting/receiving method according to claim 40, wherein at said transmission step, data related to said information is transmitted as a header and a main body, and said header indicates whether or not print-output of said information is permitted,
and wherein at said judgment step in said reception step, said header is read and it is judged whether or not said information is information without print permission.

45. The digital broadcast transmitting/receiving method according to claim 41, wherein at said transmission step, data related to said information is transmitted as a header and a main body, and said header indicates whether or not print-output of said information is permitted,
and wherein at said judgment step in said reception step, said header is read and it is judged whether or not said information is information without print permission.

46. The digital broadcast transmitting/receiving method according to claim 42, wherein at said transmission step, data related to said information is transmitted as a header and a main body, and said header indicates whether or not print-output of said information is permitted,
and wherein at said judgment step in said reception step, said header is read and it is judged whether or not said information is information without print permission.

47. The digital broadcast transmitting/receiving method according to claim 41, wherein at said transmission step, data related to said information is transmitted as a header and a main body, said main body comprising a plurality of blocks including blocks of said information part and blocks of said another information part, each of the blocks having a header indicating whether or not print-output of the block is permitted and a main body of the block,
and wherein at said judgment step in said reception step said header of said block is read and it is judged whether or not print-output of the block is permitted.

48. The digital broadcast transmitting/receiving method according to claim 42, wherein at said transmission step, data related to said information is transmitted as a header and a main body, said main body comprising a plurality of blocks including blocks of said information part and blocks of said another information part, each of the blocks having a header indicating whether or not print-output of the block is permitted and a main body of the block,
and wherein at said judgment step in said reception step said header of said block is read and it is judged whether or not print-output of the block is permitted.

49. The digital broadcast transmitting/receiving method according to claim 37, wherein said reception step includes: a judgment step of judging whether or not printing can be normally performed at said print step; and
a storage step of storing said information if it is judged that said printing cannot be normally performed.

50. The digital broadcast transmitting/receiving method according to claim 38, wherein said reception step includes:
a judgment step of judging whether or not printing can be normally performed at said print step; and
a storage step of storing said information if it is judged that said printing cannot be normally performed.
